(19) United States
(12) Patent Application Publication
(10) Pub. No.: US 2020/0018119 A1
(43) Pub. Date: Jan. 16, 2020

(54) Ladder Tray

(71) Applicant: Timothy Ellis, Lombard, IL (US)

(72) Inventor: Timothy Ellis, Lombard, IL (US)

(21) Appl. No.: 16/505,515

(22) Filed: Jul. 8, 2019

Related U.S. Application Data
(63) Continuation of application No. 15/286,109, filed on Oct. 5, 2016, now abandoned.

(51) Int. Cl. E06C 7/14; B25H 3/06; E06C 7/16

(52) U.S. Cl. CPC E06C 7/14; E06C 7/16; B25H 3/06

(57) ABSTRACT

A removable ladder tray on a step ladder. The step ladder having a ladder head, a plurality of legs and a rung between two of the plurality of legs. The removable ladder tray having a generally planar base with a ladder opening formed there through. A brace on the base top adjacent the ladder opening. The brace having a slot generally perpendicular to the top. A locking plate on the brace, the locking plate comprising a ladder head engagement surface and a fastener. The fastener having a head on the locking plate and a shaft extending through the slot whereby the locking plate is attached to the brace. The ladder in the ladder opening holding the base top between the ladder head and the rung. The ladder head engagement surface bearing against the ladder head whereby the ladder tray is held in a generally level orientation.

This application is a continuation-in-part of U.S. application Ser. No. 14/702,810, filed May 4, 2015, which is a continuation-in-part of U.S. application Ser. No. 14/310,917, filed Jun. 20, 2014 and further a continuation-in-part of U.S. application Ser. No. 29/563,458.

### BACKGROUND OF THE INVENTION

The present invention relates to a ladder-mounted tray for holding tools and materials needed for work while on the ladder. In the prior art, it is known to provide a ladder with a separate detachable tray that is mounted on the ladder in any one of a variety of ways. Some such devices rely on the openings between the ladder's rungs to support the tray. Others rely on the brackets or fasteners on the rungs or ladder head to support a tray. Still others rely on the side rails of the ladder or combinations of the side rails, rungs and openings through rungs for support purposes. Generally, a user climbs to the upper end of the ladder to perform work. On a standard ladder there is nothing at the upper end of a ladder for holding supplies or tools.

Many attempts have been made to provide some form of ladder tray for easy attachment and removal to the upper end of the ladder for holding tools and materials. In particular, ladders may be ten or twenty feet long and relatively heavy making it difficult to traverse the ladder each time a new tool is needed or to replenish working supplies. Prior art devices require fasteners or tools to attach a ladder tray. Further, the ladder tray may shield portions of the ladder, preventing full functionality of the ladder to the user or creating a dangerous situation.

Accordingly, it is desirable to provide a ladder tray which may be surroundingly attached to the top of the ladder without tools, while providing an interlocking fit to prevent the ladder tray from tipping. Further, it is desirable to provide a ladder tray which provides access to all of the rungs on the ladder including the top shelf on top of the ladder head.

### SUMMARY OF THE INVENTION

The present invention relates to a ladder tray for use on a step ladder. The step ladder may have two front legs and two back legs. A ladder head is at the top of the step ladder. The front legs and back legs pivotally attached to the ladder head wherein the top of the ladder head may provide a top shelf or step. Generally, climbing rungs are disposed on the front legs. When deployed in a usable configuration the ladder head allows the front legs, having climbing rungs thereon, to pivot about the ladder head with respect to the back legs to form an A-frame shaped stand alone step-ladder. The present invention, in a first embodiment comprises a removable ladder tray on the ladder having a base with a ladder opening formed therein. The ladder opening is generally rectangular and disposed adjacent the back of the tray. The ladder opening may have two spaced apart side edges and two spaced apart ladder leg sides.

The removable ladder tray comprises a base having a top defining an open containment area with a surrounding raised edge to prevent items from falling off the tray. A horizontal ridge may be disposed on the raised edge. The ladder may be inserted into the ladder opening having the ladder head above the tray and the climbing rungs below the tray. The ladder tray surroundingly on the step ladder with the plurality of legs in the ladder opening and the base top between the top of the ladder and the rungs. The ladder opening surroundingly fits around the ladder adjacent to and just below the ladder head thereby allowing full use and access to the all the climbing rungs and the top step located on top of the ladder head. The ladder tray may have an obliquely angled back brace wall adjacent the ladder opening. The brace having a ladder head engagement surface spaced an adjustable distance from the base top. The brace may be adapted to bear against the adjacent ladder legs. A support wall adjacent the ladder opening and opposite the brace bears against the back legs. The support wall may have tapered portions at the intersection with the side walls disposed to engage the non-vertical back legs. The brace may comprise a ladder surface, outside surface and a ladder head engagement surface spaced from the base. The ladder surface may bear against the front legs and the ladder head engagement surface bears against the ladder head. The brace may have an adjustable locking slider supporting the ladder head engagement surface. The adjustable locking slider may be releasably on the outside. The adjustable locking slider maybe adapted move along the plane of the outside surface to adjustably position the ladder head engagement surface to engage the ladder head. The adjustable locking slider is releasable held to the outside surface by a locking fastener on the adjustable locking slider. The releasable locking fastener is disposed on the adjustable locking slider to allow one handed operation by releasing the fastener thus releasing the locking slider, moving the locking slider to the predetermined position, having the ladder head engagement surface bearing against the ladder head, and tightening the releasable locking fastener, all with the same hand. The ladder head engagement surface is releasably held in the predetermined place bearing against the ladder head.

The ladder box comprises interconnected walls surrounding the ladder opening. The ladder box surrounding the ladder opening has a top and a bottom, the bottom is of similar size and shape as the ladder opening, the top is of similar shape as the bottom but may be smaller to snugly fit over the A-shaped step ladder. The ladder box may have two spaced apart vertical side walls adjacent the ladder opening. The two spaced side walls are each connected adjacent side edges and between the brace and the support wall.

Work items such as tools, paint, glue, etc. may be placed on the base causing the tray to pivot slightly about the connection point to the ladder. This pivoting motion may cause the top of the back wall to move upward towards the ladder head thereby engaging and bearing against the ladder head to hold the ladder tray in place. The sleeve like fitting of the ladder box around the ladder legs with the adjustable locking slider locked in a predetermined position to engage the ladder head are adapted to hold the removable ladder tray on the ladder and in a generally horizontal position.

The foregoing is a description of a preferred embodiment of the invention which is given here by way of example only. The invention is not to be taken as limited to any of the specific features as described, but comprehends all such variations thereof as come within the scope of the appended claims.

### DESCRIPTION OF THE DRAWINGS

FIG. 1 is a top perspective view of a ladder tray showing a first embodiment.

FIG. 2 is a top plan view of the ladder tray as shown in FIG. 1.

FIG. 3 is a bottom plan view of the ladder tray as shown in FIG. 1.

FIG. 4 is a left-side elevation view of the ladder tray as shown in FIG. 1, the right-side elevation view being a mirror image thereof.

FIG. 5 is a front elevation view of the ladder tray as shown in FIG. 1.

FIG. 6 is a top perspective view of the ladder tray as shown in FIG. 1 separated from the ladder.

FIG. 7 is a side elevation view of the ladder tray mounted on the ladder,

FIG. 8 is a top plan view of a second embodiment of the present invention.

FIG. 9 is a side elevation view of the second embodiment of the present invention.

FIG. 10 is a front elevation view of the second embodiment of the present invention.

FIG. 11 is a bottom plan view of the second embodiment of the present invention.

FIG. 12 is a back elevation view of the second embodiment of the present invention.

FIG. 13 is a top front perspective view of the second embodiment of the present invention.

FIG. 14 is a bottom front perspective view of the second embodiment of the present invention.

FIG. 15 is a bottom back perspective view of the second embodiment of the present invention.

FIG. 16 is a top plan view of a third embodiment of the present invention.

FIG. 17 is a perspective view of the third embodiment of the present invention removably attached to a ladder.

FIG. 18 is a side elevation view of the third embodiment of the present invention.

FIG. 19 is a front perspective of the third embodiment of the present invention.

FIG. 20 is an exploded perspective view of the third embodiment of the present invention.

FIG. 21 is a perspective view of a fourth embodiment of the present invention.

FIG. 22 is a perspective view of the fourth embodiment of the present invention removably attached to a ladder.

FIG. 23 is a front perspective of the fourth embodiment of the present invention.

FIG. 24 is a section view of the fourth embodiment of the present invention taken at approximately 26-26 of FIG. 23.

FIG. 25 is a section view of the fourth embodiment of the present invention taken at approximately 27-27 of FIG. 24.

FIG. 26 is a section view of the fourth embodiment of the present invention taken at approximately 28-28 of FIG. 23.

FIG. 27 is an exploded perspective of an alternate embodiment of the releasable locking fastener of FIG. 25.

FIG. 28 is an exploded perspective of a third alternate embodiment of the releasable locking fastener of FIG. 25.

### SPECIFICATION OF THE INVENTION

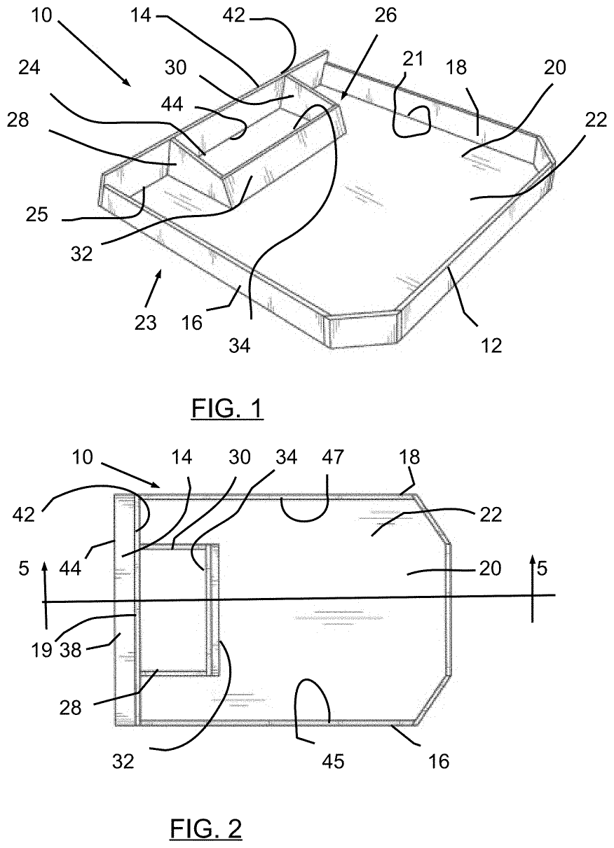

Referring to FIG. 1, the removable ladder tray 10 may comprise a front wall 12, a brace 14, a first side wall 16, a second side wall 18 and a planar base 20. Front wall 12 is generally perpendicular to base 20. Brace 14 may be obliquely attached to base 20 and spaced from front wall 12. First sidewall 16 and second sidewall 18 are generally parallel to each other and spaced apart. Base 20 may have a peripheral edge 21 surrounding a base surface 22 of the removable ladder tray 10. First sidewall 16 extends between front wall 12 and brace 14. Second sidewall 18 extends between front wall 12 and brace 14. Together, front wall 12, brace 14 and first and second sidewalls 16, 18 are attached to the periphery of base 20 and each other to form a continuous peripheral wall 23 surrounding the base top 22.

Continuing to refer to FIG. 1, a ladder opening 24 may be formed by removing material to create a hole in base 20 adjacent back edge 25 of base 20. A ladder box 26 may be attached to the base top 22 forming a tapered surrounding around the ladder opening 24. The ladder box 26 comprises two box sidewalls 28, 30 attached between the support wall and the brace 14 and extending upward from and generally perpendicular to base top 22. The support wall 32 may be obliquely connected to the base top 22. The two box sidewalls 28, 30, brace 14 and support wall 32 may be attached to give ladder box 26 a generally tapering shape surrounding and extending above ladder opening 24.

Referring to FIG. 2, the ladder box 26 further comprises a top opening 48 concentric with and smaller than ladder opening 24. Brace 14 further comprises an outside 38, a top 42 and a bottom 44. Brace top 42 may be disposed closer to the support wall 32 than bottom 44 thereby leaning brace 14 over ladder opening 24. A ladder head engagement surface 19 may be disposed on brace 14 adjacent to or on brace top 42. Brace 14 may be obliquely attached to base top 22 and ladder box sidewalls 28, 30. Box side walls 28, 30 are attached to support wall 32 to form ladder box 26 surround ladder opening 24. First sidewall 16 and second sidewall 18 may further comprise an inside surface 45, 49, respectively, disposed in a generally perpendicular orientation to base top 22.

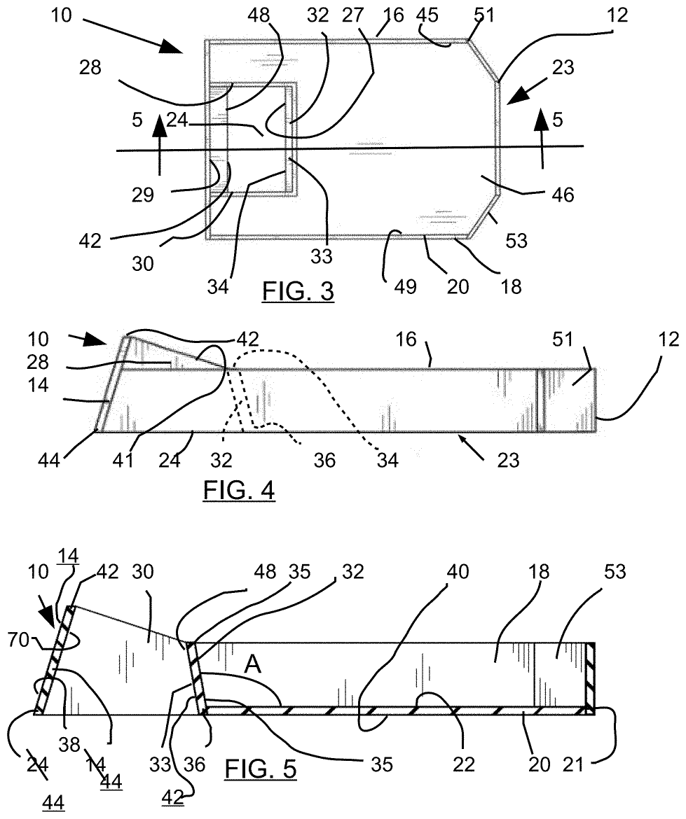

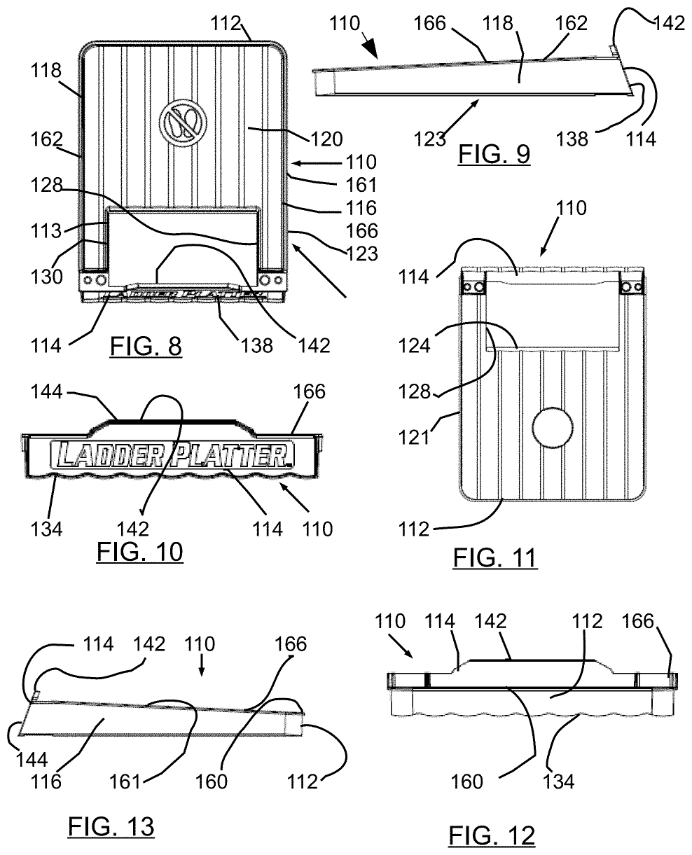

Referring to FIG. 3, the base 20 further comprises a base bottom 46. The ladder opening 24 extends through the base 20 opening to the base bottom 46. The ladder opening 24 may have a leading edge 27 and a rung edge 29. The support wall 32 may be attached to the base 20 adjacent the leading edge 27. The support wall 32 and brace 14 are obliquely attached to the base 20 to form a ladder box top opening 48 smaller than the ladder opening 24. The front wall 12 may further be connected to the first sidewall 16 by first corner piece 51. The front wall 12 may be connected to second sidewall 18 by second corner piece 53. Together, front wall 12, brace 14 and first and second sidewalls 16, 18 are attached to the periphery of base 20 and each other to form a continuous peripheral wall 23 surrounding the base top 22. It should be understood, base 20 may be round, triangular or a different shape having a surrounding peripheral wall 23 and a ladder opening 24 disposed adjacent brace 14. In the preferred embodiment, and brace 14 may be adapted to fit flush against the ladder (52, FIG. 8). Box top opening 48 may have a size smaller than ladder opening 24 by the brace 14 and support wall obliquely disposed on base 20. First sidewall 16 and second sidewall 18 may be each attached to the base 20 and attached to and extending from the front wall 12 to the brace 14.

Referring to FIGS. 4 and 5, ladder box 24 may comprise a box bottom 33 on base 20 and a box top opening 48 spaced from the base 20. Brace 14 may be larger than front wall 12 extending further above base bottom 46. Support wall 32 may be attached to base 20 having leg surface 33 disposed at an oblique angle A to top 22. The support wall 32 further comprises a support top 34 and a support bottom 36. Support wall 32 may be obliquely attached to base 20 having support top 34 disposed closer to brace 14 than support bottom 36 thereby leaning support wall 32 toward brace 14 and over ladder opening 24. First and second ladder box sidewalls 28, 30 may have a trapezoidal shape to extend from base top 22 and connect support wall 32 and brace 14. Top edge 41 of first box sidewall 28 may be disposed at an acute angle to top 22 connecting support wall 32 to brace 14.

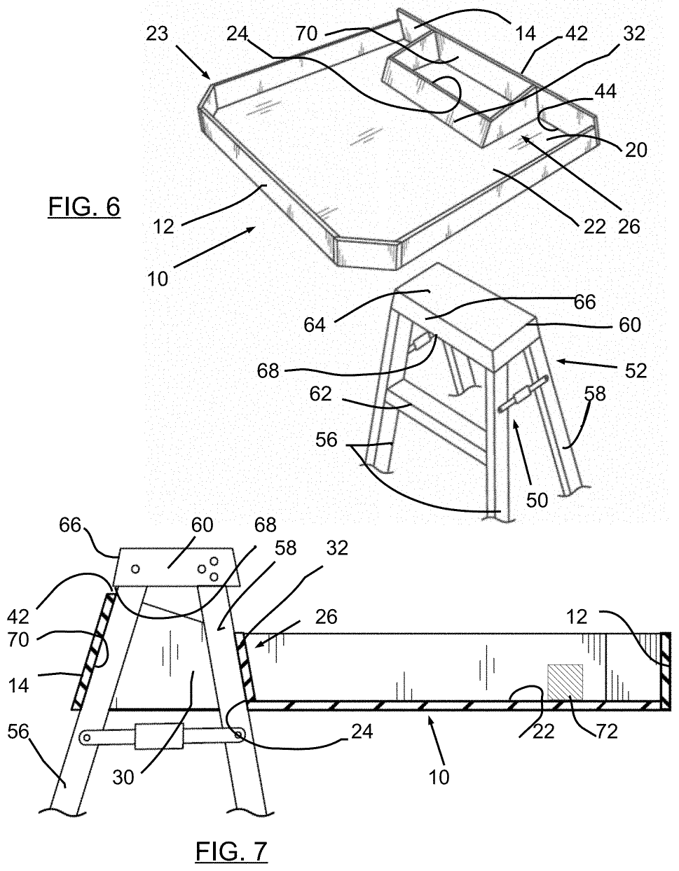

Referring to FIG. 6, the ladder tray 10 may be formed of metal or plastic. The ladder tray 10 may be formed of a single integrated molded material such as plastic molding or may be assembled by means such as welding or adhesives used to connect the base 20 to the surrounding edge 23 and the ladder box 26. The front wall 12, brace 14 and sidewalls 16, 18 may be attached to base 20 in an I-beam type configuration to provide more support, further additional beams (not shown) may be extended from the brace 14 to the front wall 12 for additional support. The removable ladder tray 10 may be surroundingly attached to a step ladder 52 by the ladder 52 removably in the ladder opening 24. Ladder 52 comprises a pair of front legs 56 and back legs 58. Front legs 56 may be joined by climbing rungs 62 disposed between front legs 56. Front legs 56 may be fixedly attached to the ladder head 60. Ladder head 60 may be disposed at the apex 50 of ladder 52. Back legs 58 may be pivotally attached to ladder head 60 to allow the legs 56, 58 to pivot from a closed position (not shown) to an A-shaped, stand alone step-ladder 52. The ladder box 26 may surround ladder opening 24 having the obliquely disposed sides adapted to press fit securely on ladder 52 between ladder head 60 and the plurality of rungs 62. The ladder head 60 may further comprises a top step 64 and a front lip 66. Front lip 66 may be attached to top step 64 and extends downwardly to bottom edge 68 disposed below top step 64.

Referring to FIG. 7, the ladder tray 10 may be removably attached to the ladder 52 by extending the apex 50 of ladder 52 through the ladder opening 24. Ladder tray 10 engages ladder 52 between ladder head 60 and rung 62. Ladder head 60 is adjacent base top 22 and may be disposed above ladder box top opening 48 having ladder box brace top 42 disposed below and adjacent to front lip bottom edge 68. Ladder engagement surface 70 on brace 14 bears against front legs 56. Likewise, support wall 32 bears against legs 58. Work material 72 on ladder tray 10 may cause the cantilever ladder tray 10 to pivot about the intersection of ladder tray 10 and ladder 52 at ladder opening 24 thereby urging a canting of the ladder tray 10 with the front 12 dropping down and the brace 14 raising up urging the ladder tray 10 to shift from a normal generally horizontal position, this canting may urge the brace top 42 to engage and bear against front lip bottom edge 68 thereby securing ladder tray 10 to ladder 52.

Continuing to refer to FIG. 7, the brace 14 bears against the front legs 56 below the ladder head 60 and above the rungs 62. The oblique angle C between brace 14 and support wall 32 may be configured to closely match the angular relationship between front legs 56 and back legs 58 to allow the ladder surface 70 to be flush against front legs 56 and support wall to be flush against back legs 58 whereby the ladder box 26 may be fitted over the top of the ladder 52.

Referring to FIGS. 8 and 11, the second embodiment of the removable ladder tray referred to as ladder platter 100 may comprise a base 120, front wall 112, brace 114 and a first side wall 116 and second side wall 118. Front wall 112 may be generally perpendicular to base 120. Brace 114 may be obliquely attached to base 120 and spaced from front wall 112. First sidewall 116 and second sidewall 118 are generally parallel to each other and spaced apart. Base 120 may have a peripheral edge 121 surrounding a base top 122 of the removable ladder tray 110. First sidewall 116 extends between front wall 112 and brace 114. Second sidewall 118 extends between front wall 112 and brace 114. Together, front wall 112, brace 114 and first and second sidewalls 116, 118 are attached to the periphery of base 120 and each other to form a continuous peripheral wall 123 surrounding the base top 122.

Continuing to refer to FIGS. 8 and 11, a ladder opening 124 may be formed by removing material to create a hole in base 120 adjacent brace 114. A ladder box 126 may be attached to the base top 122 forming a tapered shape surrounding 113 around the ladder opening 124. The ladder box 126 comprises two box sidewalls 128, 130 attached to and extending upward from and generally perpendicular to base top 122, a support wall 132 obliquely connected to the base top 122 and the two box sidewalls 128, 130. The two box sidewalls 128, 130 may be attached to and extend from support wall 132 to brace 114 to give ladder box 126 a generally tapering shape surrounding 113 and extending above ladder opening 124. Tapering shape surrounding being larger adjacent base top 122.

Referring to FIG. 9, brace 114 further comprises an outside 138, a top 142 and a bottom 144. Brace top 142 may be contoured and disposed closer to the front wall 112 than bottom 144 thereby leaning brace 114 over ladder opening 124. Front wall 112 may have a front top edge 160. First sidewall 116 may have first top edge 161. Second sidewall 118 may have second top edge 162.

Referring to FIGS. 10 and 12, the base 120 further comprises a base bottom 146. Base bottom 146 may be formed as a scalloped shape comprising a series of curved projections having ribs 134 running parallel to each other from the front wall 112 to brace 114. Scalloped ribs 134 may extend to front wall 112 and brace 114 or front wall 132. A top ridge 166 may be formed on top edges 160, 161 and 162, comprising peripheral wall 123 extending outward from base 120 thereby surrounding base top 122 on three sides. Top ridge 166 may be spaced from base top 122.

Referring to FIG. 13, brace 114 may be taller than front wall 112 extending further above base 120. Support wall 132 may be attached to base 120 having leg surface 133 disposed at an oblique angle to top 122. Support wall 132 may be obliquely attached to base 120 thereby disposing support wall 132 leaning toward brace 114 and over ladder opening 124. Support wall 132 may extend to a similar height as first and second sidewalls 116, 118. First and the second ladder box sidewalls 128, 130 may have a trapezoidal shape to extend from base top 122 and connect support wall 132 and brace 114. Top edge 141 of first box sidewall 128 may be disposed at an acute angle to top 122 connecting support wall top 132 to brace top 142. Utility holes 143 may be formed in brace 114 for holding tools (not shown).

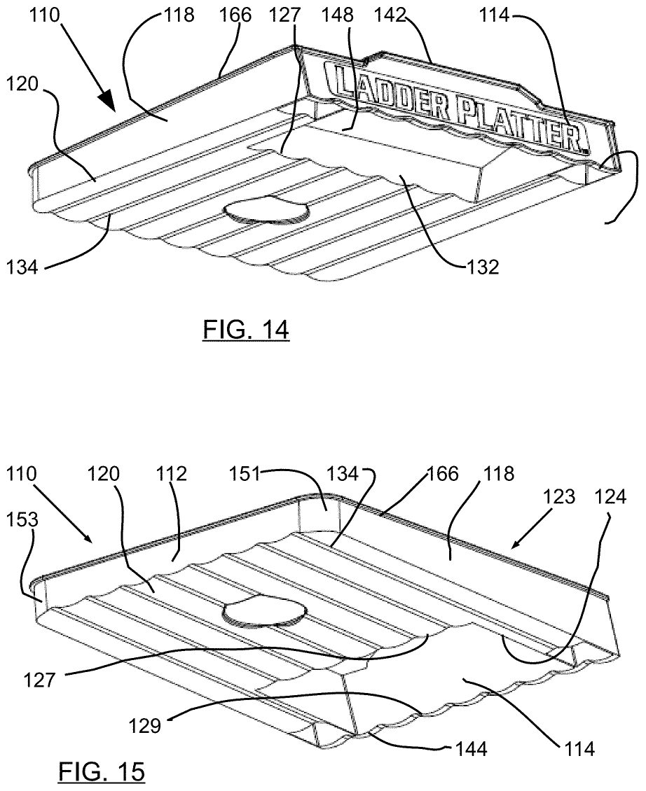

Referring to FIGS. 14 and 15, ladder opening 124 extends through the base 120. Ladder opening 124 may have a leading edge 127 and a rung edge 129. The support wall 132 may be attached to base 120 adjacent leading edge 127. Support wall 132 and brace 114 are obliquely attached to the base 120 to form a ladder box top opening 148 which may be smaller than ladder opening 124. Front wall 112 may further be connected to first sidewall 116 by first corner piece 150. Front wall 112 may be connected to second sidewall 118 by second corner piece 152 forming a contiguous base top peripheral wall 123 surrounding top 122. It should be understood, base 120 may be round, triangular or a different shape having a surrounding peripheral wall 123 and a ladder opening 124 disposed adjacent to the brace 114. Brace 114 may have a contoured ladder head engagement surface 119 to bear against ladder head bottom edge 68 (FIG. 8). Box top opening 148 may have a size smaller than ladder opening 124 by the brace 114 and support wall obliquely disposed on base 120. First sidewall 116 and second sidewall 118 may be straight and generally parallel to ribs 134.

Continuing to refer to FIGS. 14 and 15, a horizontal ridge 166 on sidewalls 116, 118 and end wall 112 may extend outward from base 120. Horizontal ridge 166 may be formed surrounding base 120. Brace 114 may have contoured top 142 adapted to engage ladder head (FIG. 7). Ribs 134 may extend from front 112 to brace 114 or support wall 132 or between first 116 and second 118 side walls.

Referring to FIG. 20. removable ladder tray 210 may comprise a generally planar base 220, front wall 212, brace 214 and a first side wall 216 and second side wall 218. Front wall 212 may be generally perpendicular to base 220. Base 220 may comprise a base top 222, and a ladder opening 224 extending through base 220 and opening at base top 222. Brace 214 may be obliquely attached to base 220 adjacent ladder opening 224 and spaced from front wall 212. First sidewall 216 and second sidewall 218 are generally parallel to each other and spaced apart. First sidewall 216 extends between front wall 212 and brace 214. Second sidewall 218 extends between front wall 212 and brace 214. Together, front wall 212, brace 214 and first and second sidewalls 216, 218 are attached to the periphery of base 220 and each other to form a continuous wall 223 surrounding the base top 222. Removable ladder tray 210 may further comprise a ladder opening 224 extending through base 220 between brace 214 and support wall 232.

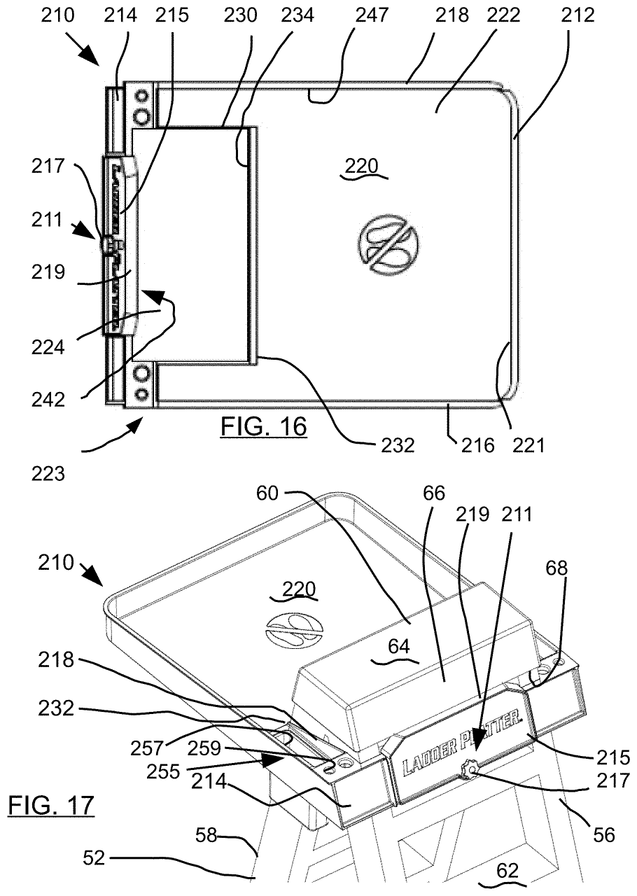

Continuing to refer to FIG. 16, brace 214 may further comprise a locking plate 215 adjustably attached to brace 214. Locking plate 215 comprises a ladder head engagement surface 219. Releasable locking fastener 211 may fix locking plate 215 at a preselected position on brace 214 with ladder head engagement surface 219 at a predetermined spacing from base 220. Locking fastener 211 may comprise knob 217 releasably attached to locking plate 215 and brace 214. Knob 217 may extend through locking plate 215 to threadably attach to brace 214 and bear against locking plate 215 urging locking plate 215 in affixed contact with brace 214.

Referring to FIG. 17, adjustable ladder tray 210 may be removably attached to ladder 52 by ladder legs 56, 58 extending through base 220 having ladder head 60 extending above brace 214 and support wall 232. The ladder head 60 may further comprises a top step 64 and a front lip 66. Front lip 66 may be attached to top step 64 and extends downwardly to bottom edge 68 disposed below top step 64. Ladder tray 210 may be positioned above ladder rung 62 and below ladder head 60. Locking plate 215 may be adjustably positioned along brace 214 to move ladder head engagement surface 219 into engagement with ladder head 60. Locking fastener 211 may have knob 217 turned to bear against locking plate 215 urging locking plate 215 against brace 214 to hold locking plate 215 in place. Snap on tool holder 255 may be snapped on to removable ladder tray 210. Openings 259 in tool holder 255 may be used for hand tools (not shown) or brush holster 257.

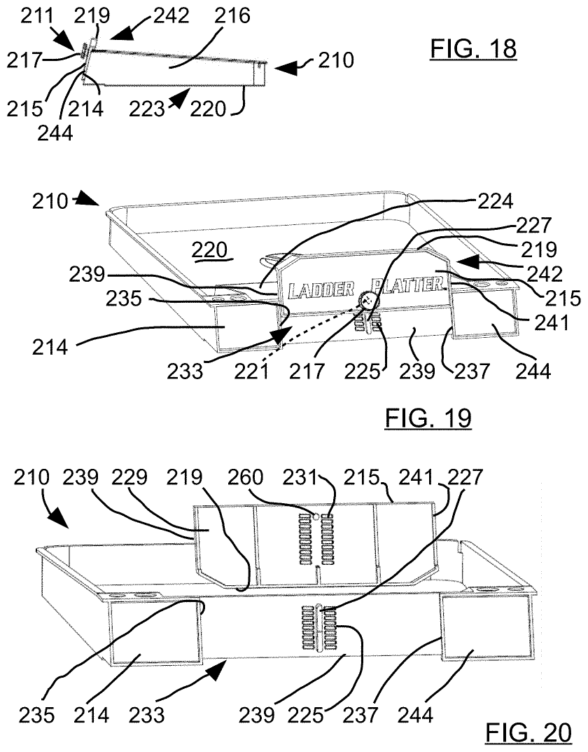

Referring to FIG. 18, releasable locking fastener 211 may be engaged to clamp locking plate 215 between knob 217 and brace 214. Locking plate 215 may be moved in a parallel path to outer surface 244 of brace 214 thereby moving ladder head engagement surface 219 to a predetermined position above base 220 and locked in place by locking fastener 211. Knob 217 may adjust to bear against locking plate 215 to urge locking plate 217 to bear against brace 214 to hold locking plate 215 in a predetermined position.

Referring to FIG. 19, brace 214 may have engagement teeth 225 disposed on outer surface 244. Engagement teeth 225 are adapted to engage locking plate 215 and retain ladder head engagement surface 219 in the predetermined position above the base 220. Brace 214 may further comprise a slider indentation 233 on outer surface 244. Slider indentation 233 may have a first indentation side 235 and second indentation side 237. First indentation side 235 and second indentation side 237 are generally parallel. Sliding surface 239 on brace 214 may be between first indentation side 235 and second indentation side 237. Locking plate 215 further comprises a first slider side 239 and a second slider side 241. First slider side 239 may sliding bear against first indentation side 235. Second slider side 241 may sliding bear against second indentation side 237. Threaded shaft 221 extends from brace through slider slot 227 to threadably engage knob 217. Knob 217 threadably traverses along threaded shaft 221 to alternatively release or bear against locking plate 215 thereby compressing locking plate 215 between knob 217 and brace 214 to hold adjustably positioned ladder head engagement surface 219 a predetermined distance above base 220 bearing against ladder head 60.

Referring to FIG. 20, locking plate 215 may be shown separated from brace 214. Locking plate 215 may further comprise brace surface 229 having mating teeth 231 adapted to engage and mesh with engagement teeth 225 when locking plate 215 is held against brace 214 by knob 217. Threaded fastener hole 260 may be formed in brace 214 at a position adjacent to and aligned with slider slot 227. Threaded shaft 221 may be attached to brace 214 at threaded fastener hole 233.

Referring to FIGS. 17, 19 and 20, ladder 52 may be inserted into ladder opening 224 having removable ladder tray 210 surroundingly engaging ladder legs 56, 58 with ladder head 60 disposed above base 220 and rung 62 positioned below base 220. Brace 214 may be disposed below ladder head 60. Locking plate 215 may be adjustably positioned with respect to base 220 to a predetermined position to urge ladder head engagement surface 219 to bear against ladder head 60. Locking fastener 217 may be engaged to hold locking plate 215 in the predetermined position. To remove removable ladder tray 210, locking fastener 217 may be disengaged to allow locking plate 215 to move to a second predetermined position wherein the ladder head engagement surface 219 does not bear against the ladder head 60 allowing removable ladder tray 210 to be lifted off ladder 52 over ladder head 60.

Referring to FIG. 21. removable ladder tray 310 may comprise a generally planar base 320, front wall 312, brace 314 and a first side wall 316 and second side wall 318. Front wall 312 may be generally perpendicular to base 320. Base 320 may comprise a base top 322, and a ladder opening 324 extending through base 320 and opening at base top 322. Brace 314 comprises outside surface 338 and ladder head engagement surface 319. Brace 314 may be obliquely attached to base 320 adjacent ladder opening 324 having outside surface 338 disposed at an oblique angle to base top 322. First sidewall 316 and second sidewall 318 may be generally parallel to each other and spaced apart. First sidewall 316 extends between front wall 312 and brace 314. Second sidewall 318 extends between front wall 312 and brace 314. Together, front wall 312, brace 314 and first and second sidewalls 316, 318 are attached to the periphery of base 320 and each other to form a continuous wall 323 surrounding the base top 322. Ladder opening 324 extends through base 320 between brace 314 and support wall 332. Support wall 332 may have shim supports 335 formed thereon. Shim supports 335 may have front leg engagement surface 337 disposed at an oblique angle to base top 322.

Continuing to refer to FIG. 21, brace 314 may further comprise releasably attached locking plate 315. Ladder head engagement surface 316 may be on locking plate 315. Locking plate 315 may be releasably attached to brace 314 by releasable locking fastener 311 on locking plate 315.

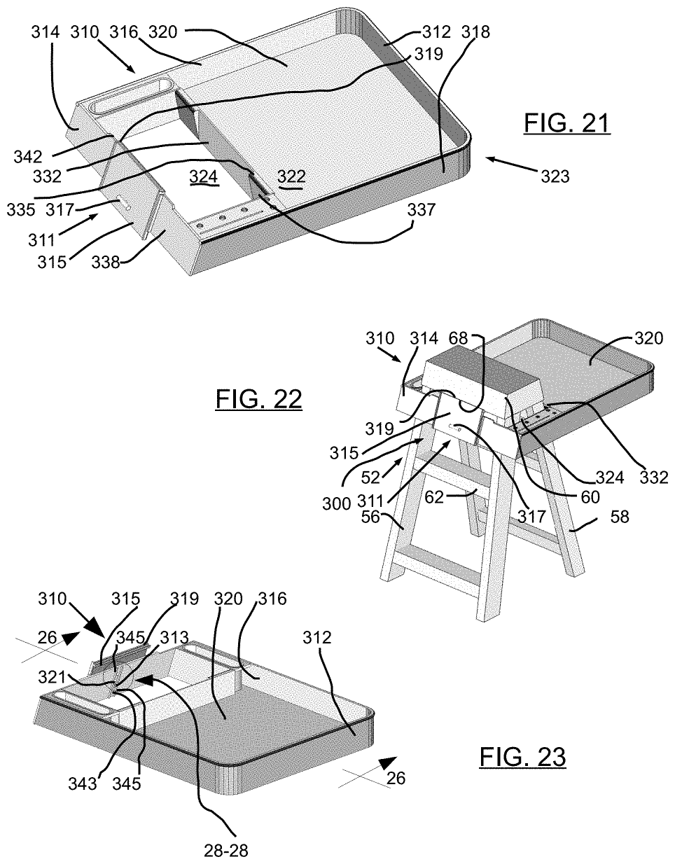

Referring to FIG. 22, adjustable ladder tray 310 may be removably attached to ladder 52 by ladder legs 56, 58 extending through ladder opening 324 having ladder head 60 disposed above brace 314 and support wall 332. Ladder tray 310 may be positioned below ladder head 60. Locking plate 315 may be adjustably positioned on brace 314 at a predetermined position 300 to urge ladder head engagement surface 319 to bear against ladder head 60. Releasable locking fastener 311 may be attached to locking plate 315 to allow a one handed adjustment by releasing releasable locking fastener 311, moving locking plate 315 into a desired position and locking releasable locking fastener 311 to hold locking plate 315 in the desired position. Locking fastener may comprise a thumb screw 317 rotationally attached to locking plate 315 and slidably attached to brace 314. Thumb screw 317 may be threadably adjusted to bear against locking plate 315 urging locking plate 315 to bear against brace 314 clamping locking plate between thumb screw 317 and brace 314 thereby holding locking plate 315 in the desired position on brace 314 with ladder head engagement surface 319 bearing against ladder head 60.

Referring to FIG. 23, releasable locking fastener 311 may further comprise a threaded shaft 313 threadably engaged to sliding nut 321, whereby turning threaded shaft 313 urges threaded shaft 313 to rotationally traverse in sliding nut 321. Sliding nut 321 slidingly rides in front of brace slot 343 on brace 314. Sliding nut 321 may be held in rotational position adjacent brace slot 343 by tracks 345 disposed on both sides of brace slot 343. Tracks 345 are ridges framing brace slot 343 spaced from each other a predetermined distance approximately equal to or slightly less than the width of sliding nut 321. sliding nut 321 is on brace between tracks 345 to rotationally hold sliding nut 321 adjacent brace slot 343 while allowing threaded shaft 313 to traverse in sliding nut 321 and traverse vertically in brace slot 343. Threaded shaft 313 extends from thumb screw 317 through locking plate 315 and through brace slot 343 to threadably engage sliding nut 321 to releasably secure locking plate 315 to brace 314 by clamping locking plate 315 between thumb screw and sliding nut 321 against brace 314 to hold ladder head engagement surface 319 in a predetermined position above base 320.

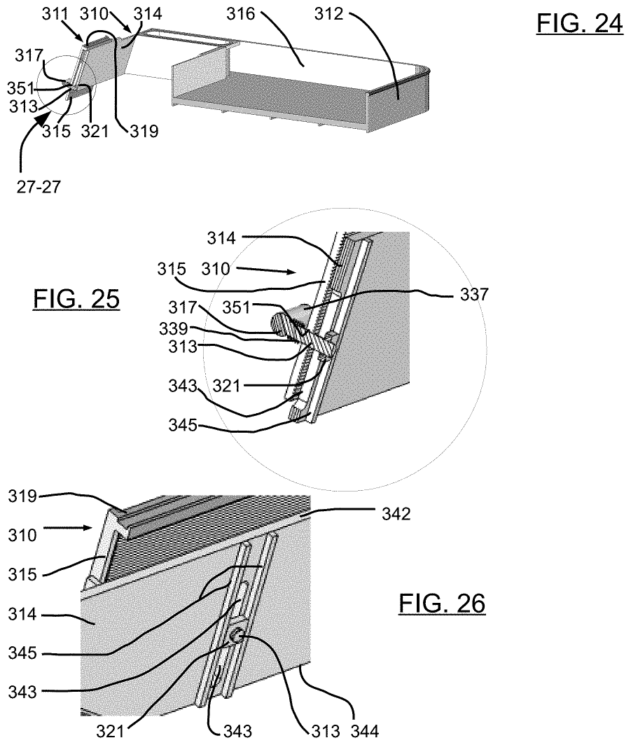

Referring to FIG. 24, thumb screw 317 may be attached to threaded shaft 313. Thumbscrew 317 is rotationally attached to locking plate 315 by threaded shaft 313 extending through fastener hole 351 in locking plate 315. Threaded shaft 313 may extend through brace slot 343 to threadably engage sliding nut 321 disposed between and bearing against tracks 345.

Referring to FIGS. 25 and 26, thumb screw 317 may comprise a handle 337 on threaded shaft 313. Threaded shaft 313 may be rotationally fastened to locking plate 315 by extending through fastener hole 351 in locking plate 315. Threaded shaft 313 may extend through brace slot 343 to threadably engage rectangular sliding nut 321 disposed between and bearing against tracks 345. Tracks 345 are adapted to prevent sliding nut from turning with threaded shaft 313. Brace slot 343 extends from adjacent brace top 342 to adjacent brace bottom 344. Threaded shaft 313 may threadably traverse in sliding nut 321. Turning handle 337 urges threaded shaft to traverse in sliding nut 321 urging handle 337 to bear against locking plate 315 clamping locking plate 315 in the desired position. Threaded shaft 313 traversing in sliding nut 321 may cause handle 337 to traverse towards or away from brace 314. When tightened, handle 337 may clamp locking plate 315 between handle 337 and sliding nut 321 thereby releasably holding locking plate 315 in the desired position. Sliding nut 321 slidingly rides adjacent slot 343 having brace 314 between sliding nut 321 and locking plate 315. Spring 339 on threaded shaft 313 may be disposed on threaded shaft 313 between handle 317 and locking plate 315.

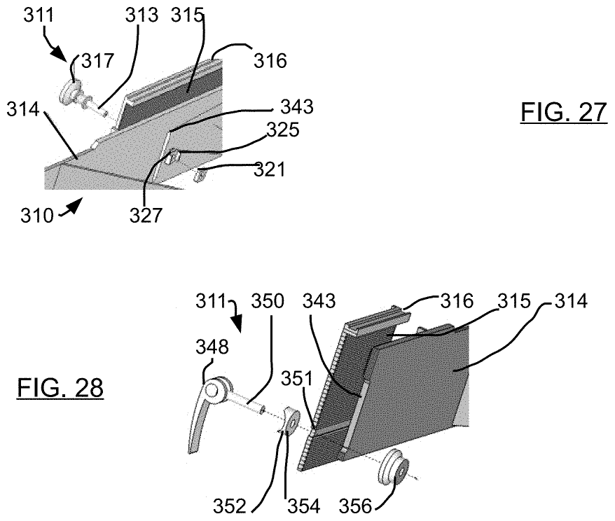

Referring to FIG. 27, releasable locking fastener 311 may alternatively comprise a handle 317 with a knob shape having threaded shaft 313 on handle 317 and extending through brace slot 343 to threadably engage sliding nut 321. Nut retainer 325 may be adapted to engage sliding nut 321 and traverse in brace slot 343 by retainer protrusions 327 extending from nut retainer 325. protrusions 327 may extend into brace slot 343 to rotationally retain sliding nut 321 and traverse with locking plate 315. Locking nut bears against nut retainer 325 when threaded shaft 313 traverses in locking nut urging handle 317 to bear against locking plate 315 holding locking plate 315 in position against brace 314.

Referring to FIG. 28, the releasable locking fastener 311 may be a quick release fastener type similar to cam locks used to hold a bicycle seat in place. Locking fastener 311 may comprise a threaded stud 350, a cam lever 348, a cam washer 362 and a lock nut 356. Threaded stud 350 is rotationally attached to cam lever 348. Threaded stud 350 may be inserted in cam washer 354. Cam washer 354 may have tray surface 354 bearing against locking plate 315. Threaded stud 350 is rotationally attached to locking plate at fastener hole 351. Threaded stud 350 extends through fastener hole 351 and through brace slot 343 to engage lock nut 356. Lock nut 356 is adjustably disposed on threaded stud 350 at a predetermined position whereby cam lever is moved about the rotational attachment to threaded stud 350 urging the locking nut 356 to bear against brace 314 squeezing locking plate 315 between cam washer 352 and brace 314 to hold locking plate 315 in the predetermined vertical position.

In use and referring to FIG. 7, the removable ladder tray 10 may be removably attached to ladder 52 without tools or fasteners. Ladder head 60 may be disposed in ladder opening 24. Brace 14 bears against ladder head 60 to secure ladder tray 10 to ladder 52. Disengaging brace 14 from ladder head 60 allows ladder tray 10 to be lifted off ladder 52.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

I claim:

1. A removable ladder tray adapted to removably attach to a step ladder, the step ladder having a plurality of legs, a step and a ladder head, each of the plurality of legs attached to the ladder head, the step on two of the plurality of legs, the step spaced from the ladder head, the ladder head comprising a top step and a front lip, the front lip comprising a bottom edge, the removable ladder tray adapted to mount on the ladder between the step and the top step, the removable ladder tray comprising:
a base comprising a top, a bottom, a ladder opening and a brace, the ladder opening extending through the base from the top to the bottom, the brace adjacent to the ladder opening, the brace comprising a generally rectangular planar shape, the brace further comprising an inside, a locking side, a bottom and a slot, the brace bottom on the top, the brace inside adjacent the ladder opening, the slot extending through the brace from the inside to the locking plate side;
an adjustable locking plate, the adjustable locking plate comprising a ladder head engagement edge surface, a brace side and an outside, the brace side bearing on the locking plate side, a fastener hole in the adjustable locking plate, a fastener in the fastener hole, the fastener comprising a shaft and a head, the shaft in the fastener hole, the shaft extending through the slot, the fastener head bearing on the outside; and a nut, the nut bearing on the inside adjacent the slot, the nut threadably on the shaft urging the head to bear against the outside and the nut to bear against the inside whereby the adjustable locking plate is held against the brace disposing the ladder head engagement surface a predetermined spacing from the top.

2. The removable ladder tray of claim 1, wherein the brace further comprises engagement teeth, the engagement teeth on the locking side, the engagement teeth bearing on the adjustable locking plate.

3. The removable ladder tray of claim 2 wherein the adjustable locking plate further comprises a plurality of mating teeth on the brace side, the mating teeth meshed with the engagement teeth.

4. The removable ladder tray of claim 1, wherein the shaft further comprises threads, the shaft rotationally attached to the nut, the shaft threadably traversing in the nut to urge the head to bear against the locking plate, the nut bearing against the brace

5. The removable ladder tray of claim 4, further comprising a ladder box on the top, the ladder box comprising a pair of opposing sidewalls and a support wall, the pair of opposing sidewalls on the top adjacent the ladder opening, each of the pair of opposing sidewalls on the brace, the support wall on the top, the support wall spaced from the brace, the support wall on each of the opposing sidewalls.

6. The removable ladder tray of claim 1, further comprising a pair of tracks on the brace inside, the brace slot between the pair of tracks, the nut disposed between the pair of tracks.

7. The removable ladder tray of claim 6, further comprising a nut retainer, the nut retainer on the nut, the nut retainer attached to each one of the pair of tracks.

8. The removable ladder tray of claim 6, further comprising a nut retainer, the nut retainer comprising a protrusion, the protrusion in the brace slot.

9. The removable ladder tray of claim 1 further comprising tool holder on the ladder tray.

10. A removable ladder tray for mounting on a step ladder, the step ladder comprising a ladder head and a plurality of legs, the ladder head having a bottom edge, the removable ladder tray comprising:
a base, the base comprising a base top, a base bottom, a ladder box, a brace and a ladder opening, the ladder opening extending from the base top to the base bottom, the ladder box on the base top, the ladder box surrounding the ladder opening, the brace on the top, the ladder box comprising a pair of spaced sidewalls and a support wall, the pair of spaced sidewalls on the brace, the support wall on each of the pair of opposing sidewalls, the support wall spaced from the brace, the brace comprising an inside, a locking plate side, a bottom and a slot, the brace bottom on the base top, the brace slot formed in a generally vertical orientation, the brace slot extending from the inside to the locking plate side; and
a locking plate, the locking plate comprising a fastener hole, an outside, a brace side and a ladder head engagement surface, the brace side bearing on the locking plate side, the ladder head engagement surface disposed a predetermined spacing from the base top, a fastener in the fastener hole, the fastener having a threaded shaft, a sliding nut and a fastener head, the fastener head on a first end of the shaft, the shaft in the fastener hole, the shaft extending through the brace slot, the sliding nut threadably traversing on the shaft adjacent the brace inside, the fastener head bearing on the outside, the locking plate between the fastener head and the brace, the brace between the locking plate and the sliding nut, the ladder head engagement surface spaced from the base top.

11. The removable ladder tray of claim 10, wherein the brace and the pocking plate are disposed between the fastener head and the sliding nut.

12. The removable ladder tray of claim 11, wherein the nut is adjustably disposed with respect to the base top as the shaft travels in the brace slot.

13. The removable ladder tray of claim 12, further comprising a pair of tracks on the brace inside, the slot between the pair of tracks, the slot generally parallel to the pair of tracks, the sliding nut between each one of the pair of tracks whereby the pair of tracks retains the sliding nut adjacent the slot.

14. The removable ladder tray of claim 10, wherein the brace further comprises engagement teeth on the locking plate side, the adjustable locking plate further comprises a plurality of mating teeth on the brace side, the plurality of mating teeth meshed with the engagement teeth.

15. The removable ladder tray of claim 10, wherein the support wall is disposed at an obtuse angle to the base top.

16. The removable ladder tray of claim 15, wherein the pair of opposing sidewalls are each trapezoidal shaped, the pair of sidewalls held in spaced relation by the support wall.

17. A removable ladder tray adapted to removably attach to a step ladder, the step ladder having a plurality of legs, a step and a ladder head, the ladder head having a top and a bottom edge, each of the plurality of legs attached to the ladder head, the step on one of the plurality of legs, the step spaced from the ladder head, the removable ladder tray adapted to surroundingly attach on the ladder between the step and the ladder head, the removable ladder tray comprising:
a base, the base comprising a base top, a base bottom, a periphery wall and a ladder opening, the periphery wall comprising a brace on the base top, the brace having an inside, a locking plate side and a brace slot, engagement teeth on the locking plate side, the ladder opening extending from the base top to the base bottom, the ladder opening adjacent the brace;
an adjustable locking plate, the adjustable locking plate on the brace outside, the locking plate comprising a brace surface, an outside, a fastener hole and a ladder head engagement surface, the brace surface comprising a plurality of mating teeth, the brace surface bearing against the locking plate side, the mating teeth meshed with the engagement teeth, the ladder head engagement surface spaced from the base top at a predetermined spacing; and
a fastener, the fastener comprising a head, a shaft and a nut, the head bearing on the adjustable locking plate outside, the fastener shaft in the fastener hole, the fastener shaft in the brace slot, the fastener nut on the shaft spaced from the head, the fastener nut bearing on the brace inside, the locking plate between the fastener head and the fastener nut.

18. The removable ladder tray of claim 17, wherein the brace further comprises a peripheral wall around base top.

19. The removable ladder tray of claim 18, further comprising a ladder box on the top, the ladder box comprising two box sidewalls and a support wall on the brace, the two box sidewalls on the top, the support wall on the top, the brace on the support wall and each of the two box sidewalls, each of the two sidewalls extending upward from and generally perpendicular to base top, each one of the two sidewalls spaced from the other of the two side walls.

20. The removable ladder tray of claim 19, wherein the support wall is obliquely connected to the base top.
